(19) United States
(12) Patent Application Publication
(10) Pub. No.: US 2005/0046894 A1
(43) Pub. Date: Mar. 3, 2005

(54) Image creating service system and image creation ordering method

(75) Inventors: Moeko Hagiwara, Ichikawa-shi (JP); Takashi Igarashi, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Photo Imaging, Inc., Tokyo (JP)

(21) Appl. No.: 10/922,780

(22) Filed: Aug. 20, 2004

(30) Foreign Application Priority Data
Aug. 29, 2003 (JP) JP2003-307718

(51) Int. Cl. G06F 15/00

(52) U.S. Cl. 358/1.15

(57) ABSTRACT

This image creating service system has a network 1, a user terminal 3 connected to the network 1 for ordering image creation, and an ordering server 2 connected to the network 1 having selection information of a plurality of image preparer, selects a predetermined image preparer from the selection information of a plurality of image preparer from the user terminal 3, and orders image creation to the selected image preparer.

### TECHNICAL FIELD

The present invention relates to an image creating service system capable of receiving image creating services of a portrait or a picture such as a building or a famous place of an image of a desired style by selecting an image preparer desired by a user via a network.

### BACKGROUND

Conventionally, a portrait preparer can prepare a handwritten portrait even if he does not stay in the place and preserves and controls the portrait as electronic data in a data base in a control host computer and the portrait can be shared as data to be printed on or outputted to various commodities (for example, Japanese Patent Application 2003-67585).

Meanwhile, in a conventional portrait creating system, a portrait preparer can prepare a handwritten portrait even if he does not stay in the place, though a user cannot select freely a portrait preparer, so that a portrait of a portrait preparer may not coincide with his desire.

Further, for example, a portrait may find various applications such as the Web screen or portable standby and when a portrait is used as a present for a celebration such-as childbirth, a birthday, or Old People's Day or as a present at a stage of growth such as a festival for children of three, five, and seven years of age or entrance into a school, it is a present a bit different from others. Furthermore, original goods such as calling cards or memos can be created by a completed portrait, so that how to enjoy a portrait is extended more.

As mentioned above, there is a case that a user wants to bring his portrait close to his original image depending on the use and particularly to exaggerate characteristics of the hair style, eyes, and nose, and furthermore, there is a case that not limited to the portrait, he requires an image of a building and/or a famous place, and if he can select an image preparer according to such a case, a portrait satisfied more by him can be provided.

### SUMMARY

The present invention was developed with the foregoing in view and is intended to provide an image creating service system capable of receiving image creating services of a portrait or an image such as a building or a famous place by selecting an image preparer desired by a user.

To accomplish an object, the present invention is structured as indicated below.

(1) The image creating service system of the present invention having a network, a user terminal connected to the network for ordering image creation, an ordering server connected to the network having selection information of a plurality of image preparer, a selection device for selecting a predetermined image preparer from the user terminal on the basis of the selection information of a plurality of image preparer, an ordering device for ordering image creation to the selected image preparer, and a device for sending information necessary to prepare the image of the user when ordering the image creation.

By use of the constitution described in item (1), the predetermined image preparer is selected from the selection information of a plurality of image preparer from the user terminal, and image creation is ordered to the selected image preparer, thus image creating services of a portrait desired by the user or an image of a building or a famous place can be received.

(2) Further, in the image creating service system described in item (1), the order of image creation is given using a photographic image of the user.

By use of the constitution described in item (2), the order of image creation is given using the photographic image of the user and an image of a desired style can be created by the image data held by the user.

(3) Further, in the image creating service system described in item (1), the kind of the created image includes a portrait.

By use of the constitution described in item (3), an image creating service of at least a portrait is received, so that it finds various applications such as the Web screen or portable standby.

(4) Further, in the image creating service system described in item (1), the selection information of a plurality of image preparer includes any of at least the name of the image preparer, portrait, profile, style, created sample, popularity, existence of an own handwriting original image order, and created image kind.

By use of the constitution described in item (4), the selection information of a plurality of image preparer includes any of at least the name of the image preparer, portrait, profile, style, created sample, popularity, existence of an own handwriting original image order, and created image kind and the user, for example, according his desire or use, can select easily an image preparer.

(5) Further, in the image creating service system described in item (4), the popularity is decided by the voting of satisfaction by the user from the user terminal on the basis of the created image.

By use of the constitution described in item (5), the popularity is decided by the voting of satisfaction by the user from the user terminal on the basis of the created image and an image preparer reflected by the satisfaction of the user can be selected.

(6) Further, in the image creating service system described in item (4), the popularity is decided by the selection count of each image preparer from the user terminal.

By use of the constitution described in item (6), the popularity is decided by the selection count of each image preparer from the user terminal and an image preparer reflected by the selection count of the user can be selected.

(7) Further, in the image creating service system described in any one of item (1) to (6), the user terminal transmits an original image of image creation to the ordering server via the network as the information of necessity for creating image.

By use of the constitution described in item (7), the information necessary for an original image for image creation and creating thereof is transmitted to the ordering server, so that the image preparer can prepare an image more satisfied by the user.

(8) Further, in the image creating service system described in any one of item (1) to (7), the image creation includes a digital image and an own handwriting original image.

By use of the constitution described in item (8), the image creation includes a digital image and an own handwriting original image, and the digital image is used for, for example, the Web screen or portable standby, and the own handwriting original image is used as a present, so that how to enjoy can be extended more.

(9) Further, in the image creating service system described in item (8), the created digital image can be read by the user by the URL of an ordering manager.

By use of the constitution described in item (9), the created digital image can be read by the user by the URL of the ordering manager and can respond to a correction from the user.

(10) Further, in the image creating service system described in item (8), the created own handwriting original image is ordered from the user terminal.

By use of the constitution described in item (10), the created own handwriting original image can be ordered easily from the user terminal.

### BRIEF DESCRIPTION OF THE DRAWINGS

FIG. 1 is a drawing showing an image creating service system.

FIG. 2 is a drawing for explaining the flow of the image creating service system.

FIG. 3 is a selection screen of image preparers displayed on a user terminal.

FIG. 4 is a drawing showing an image up-load screen.

FIG. 5 is a drawing showing a portrait information setting screen.

FIG. 6 is a drawing showing an ordering user information input screen.

FIG. 7 is a drawing showing an ordering content confirmation screen.

FIG. 8 is a drawing showing an order confirmation screen.

FIG. 9 is a drawing showing a log-in screen to the URL.

FIG. 10 is a drawing showing a satisfaction voting screen.

FIG. 11 is a drawing showing an ordering screen of a created image.

FIG. 12 is a drawing showing an own handwriting original image ordering screen.

FIG. 13 is a drawing showing a print ordering screen.

### DESCRIPTION OF THE PREFERRED EMBODIMENTS

The embodiment of the image creating service system of the present invention will be explained below, though the present invention is not limited to this embodiment. Further, this embodiment of the present invention is a most preferable embodiment of the invention and the terms of the present invention are not limited to those indicated below.

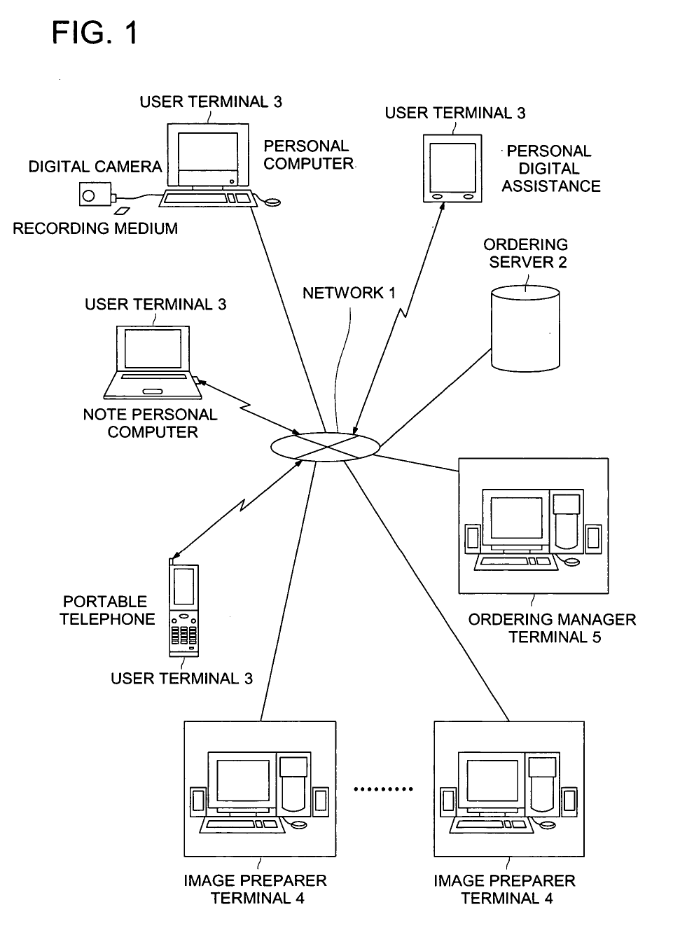

FIG. 1 is a drawing showing the image creating service system. In FIG. 1, to a network 1, an ordering server 2, a user terminal 3, image preparer terminals 4, and an ordering manager terminal 5 are connected and these units can be communicated respectively via the network 1.

The network 1 is composed of a computer system, a terminal, and data communication equipment which are connected to each other. The units may be connected by wires such as a leased circuit or a public circuit, or may be connected by radio via a communication satellite, or may be connected by a combination thereof. The so-called Internet is also included in the network.

The ordering server 2, via the network 1, executes reception of an image creating order, ordering of an image creating operation on the basis of the image creating order, and ordering management and also has a function for providing network image creating services such as reading and storing of selection information of a plurality of image preparer used for the image creating order and customer information management.

The user terminal 3 may be an electronic device terminal capable of transmitting and receiving character information and image information such as a personal computer, a personal digital assistance (PDA), or a portable telephone. A personal computer and a personal digital assistance (PDA) can be connected to a digital camera and provided with a recording medium recording images to read images and can read images from a scanner. A portable telephone having a digital camera can read images picked up by the digital camera and a portable telephone having no digital camera can receive and read images by communication from other electronic devices.

The user terminal 3 selects a predetermined image preparer from the selection information of a plurality of image preparer, transmits the original image of image creation and information necessary for creating to the ordering server 2, and orders image creating to the selected image preparer. The selection information of a plurality of image preparer includes any of at least the name of the image preparer, portrait, profile, style, created sample, popularity, existence of an own handwriting original image order, and created image kind. The created image kind includes at least a portrait and may include images of buildings and famous places.

The popularity, on the basis of the created image, is decided by the voting of satisfaction by a user from the user terminal 3. Further, the popularity may be decided by the selection count of each image preparer from the user terminal 3 or may be decided by using accumulated evaluation from the user which will be described later.

As an original image for image creation, an image picked up by a digital camera or a portable telephone camera is connected to and read by the user terminal 3 or an image recorded on a printing paper or an ordinary paper is read and transmitted by a scanner. Information necessary for creating is, for example, when the image to be created is a portrait, the distinction of sex, age, and existence of background selection. In this case, it is possible to make an application for creating of an image from the user terminal 3 and separately send the image recorded on the printing paper or ordinary paper of a user to an order placing manager or an image preparer by mail or rapid delivery to house service.

Further, when preparing a digital image or an own handwriting original image by an image preparer or preparing only an own handwriting original image, a user can order the created own handwriting original image to the image preparer.

The ordering manager terminal 5 can receive an image creation order via the ordering server 2, on the basis of the image creating order, order the image creating operation to the selected image preparer, and manage order reception and placement, and also can display the image used for image creation. Further, the created digital image can be read by the user by the URL of the ordering manager and can respond to a correction from the user.

The image preparer terminal 4 is arranged in a company or an office of an image preparer and on the basis of an order of the image creating operation on the image creation screen, performs the image creating operation.

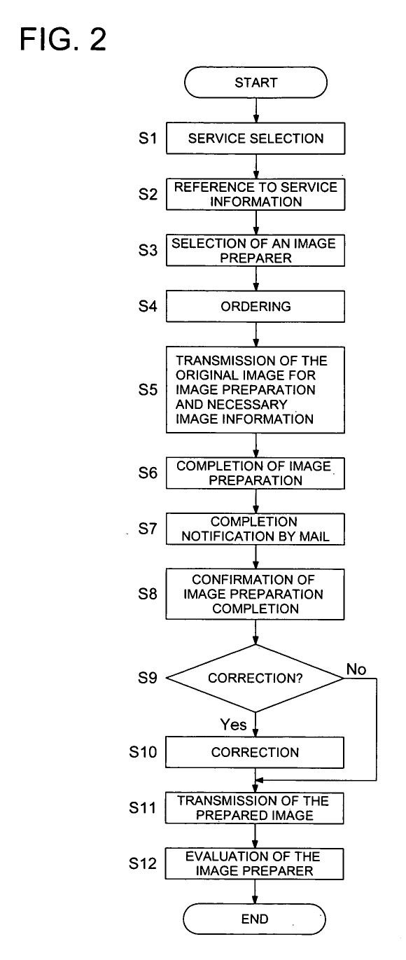

Next, the flow of the image creating service system will be explained by referring to FIG. 2. From the user terminal 3, the user selects, for example, the portrait service, which can be provided, from the provided services (Step S1), refers to the selection information of a plurality of image preparer (Step S2), and selects a predetermined image preparer (Step S3). When the image preparer is selected in this way, the process goes to Step S4 (Order) and the original image for image creation and information necessary for creating are input and are transmitted to the ordering server 2 (Step S5).

When the selected image preparer prepares and finishes an image on the basis of the original image for image creation and information necessary for creating (Step S6), the manager transmits a notification of completion to the user by mail (Step S7) and the created digital image can be read by the URL of the ordering manager (Step S8). The user reads the created digital image by the URL of the ordering manager and if a correction is necessary, transmits a correction instruction (Step S9). On the basis of the correction instruction, the image preparer corrects the image and when the correction is finished (Step S10), transmits the created image to the user (Step S11).

Transmission of the created image to the user is executed by down-loading of the created digital image at the user terminal 3. Or, the created image is printed and mailed by the manager. Or, when an own handwriting original image is ordered, it is mailed.

The user receives the created image and evaluates the selected image preparer. The evaluation is executed, for example, on the basis of the created image, by voting the satisfaction by the user from the user terminal 3 (Step S12).

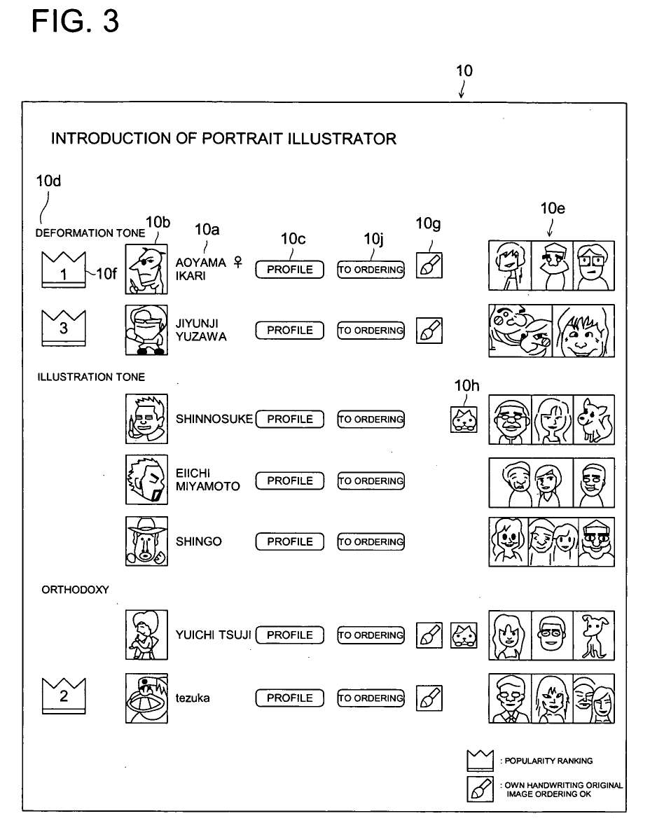

Next, the image creating service system will be explained according to the operation screen. FIG. 3 is a selection screen of image preparers displayed on the user terminal.

On a selection screen 10 of image preparers in this embodiment, as selection information of a plurality of image preparer, a name of an image preparer 10a, a portrait 10b, a profile 10c, a style 10d such as a deformation tone, an illustration tone, or orthodoxy, created samples 10e, popularity 10f, existence of an own handwriting original image order 10g, and a created image kind 10h are displayed. When the button of the profile 10c is clicked, a screen introducing a detailed history, age, and main works is displayed. Further, this embodiment is a system for preparing a portrait by an image preparer and the created image kind 10h indicates that a image of a pet can be created.

As mentioned above, the user can easily select an image preparer, for example, according to his desire or use and on the basis of introduction of a plurality of image preparer, he can select a predetermined image preparer by clicking an order button 10j.

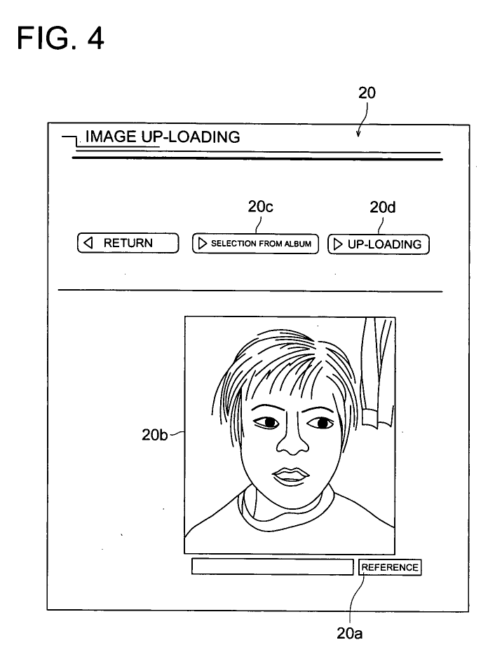

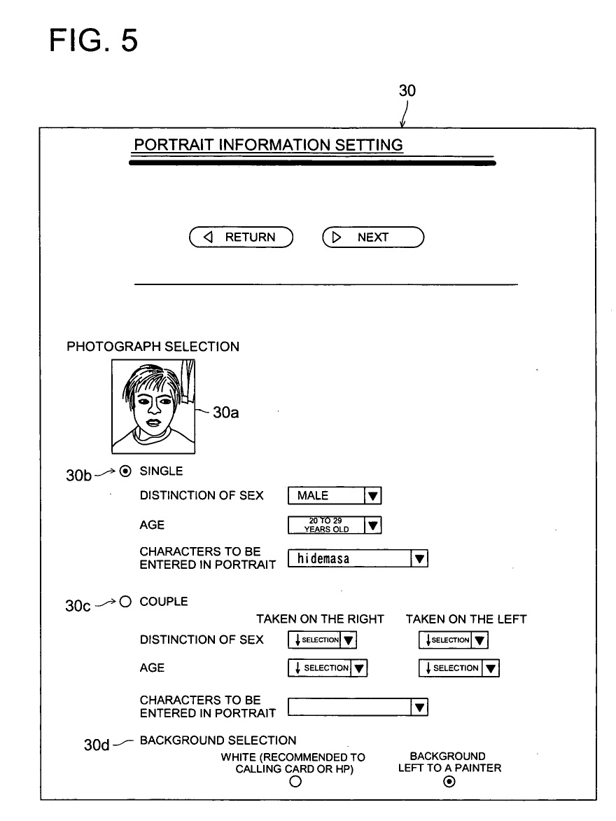

FIG. 4 shows the image up-load screen and FIG. 5 shows the portrait information setting screen.

At the user terminal 3 in this embodiment, a reference button 20a is selected on an image up-load screen 20 shown in FIG. 4 and an image 20b of the original image for image creation is designated. The image 20b of the original image for image creation can be designated from the online album, for example, by clicking an online album button 20c. When the designation of the image is finished, the image is transmitted by clicking an up-load button 20d.

In this embodiment, the image creating order is given by using a photographic image of the user and in this case, by the image date held by the user, an image can be created in a desired style.

Further, at the user terminal 3 in this embodiment, an image of the original image for image creation is displayed on a photograph selection display 30a on a portrait information setting screen 30 shown in FIG. 5, and when preparing a portrait of one person, the radio button of a single designation unit 30b is checked, and when preparing portraits of two persons, the radio button of a couple designation unit 30c is checked. The designation is executed exclusively and the two cannot be designated at the same time. In the example shown in FIG. 5, single is designated and the state that the radio button of the single designation unit 30b is checked is shown.

Further, by the single designation unit 30b, characters including the distinction of sex, age, and portrait can be set.

When the couple designation unit 30c is checked, a person taken on the right and a person taken on the left are set similarly to the single designation unit 30b and at background selection 30d, whether the background of the portrait is whitened or left to a painter can be selected.

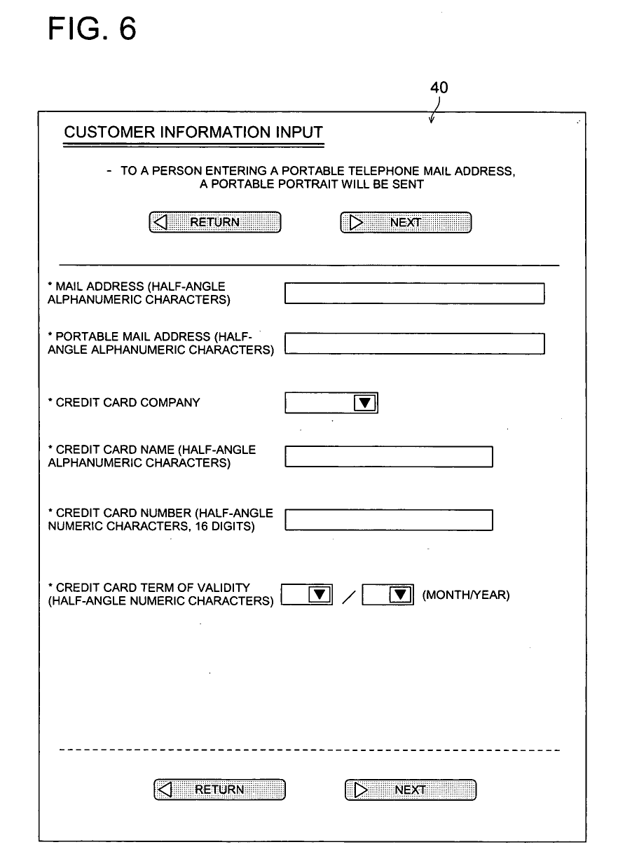

When the original image for image creation and information necessary for creating are transmitted to the ordering server 2 like this, the image preparer can prepare an image more satisfied by the user. FIG. 6 shows the ordering user information input screen. At the user terminal 3 in this embodiment, on an ordering user information input screen 40 shown in FIG. 6, a mail address (half-angle alphanumeric characters), a portable telephone mail address (half-angle alphanumeric characters), a credit card company, a credit card name (half-angle alphanumeric characters), a credit card number (half-angle numeric characters, 16 digits), and a credit card term of validity (half-angle numeric characters) are input and to a user entering the portable telephone mail address, a portable telephone portrait can be transmitted.

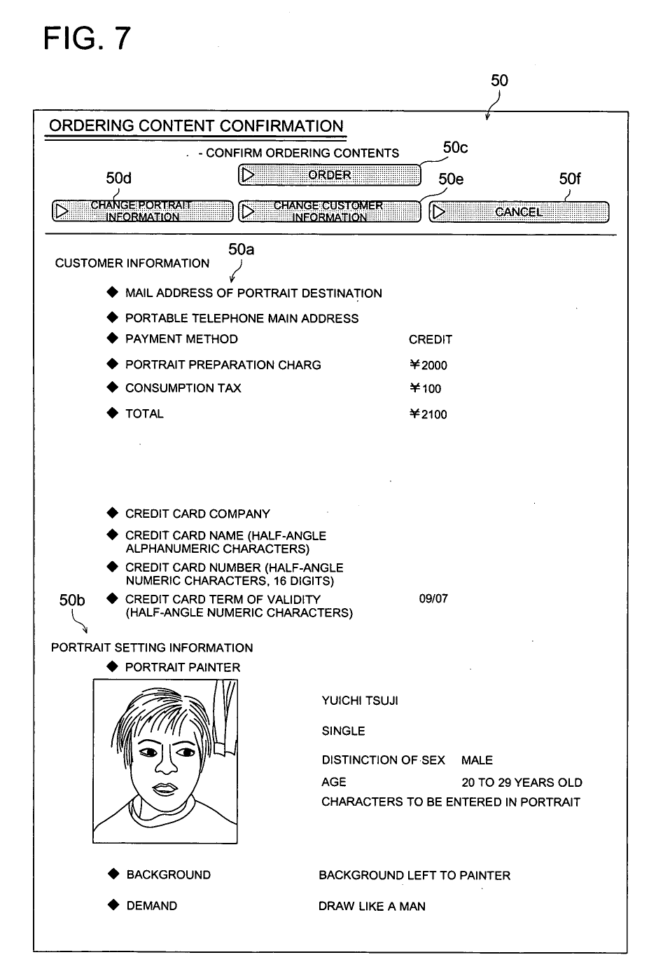

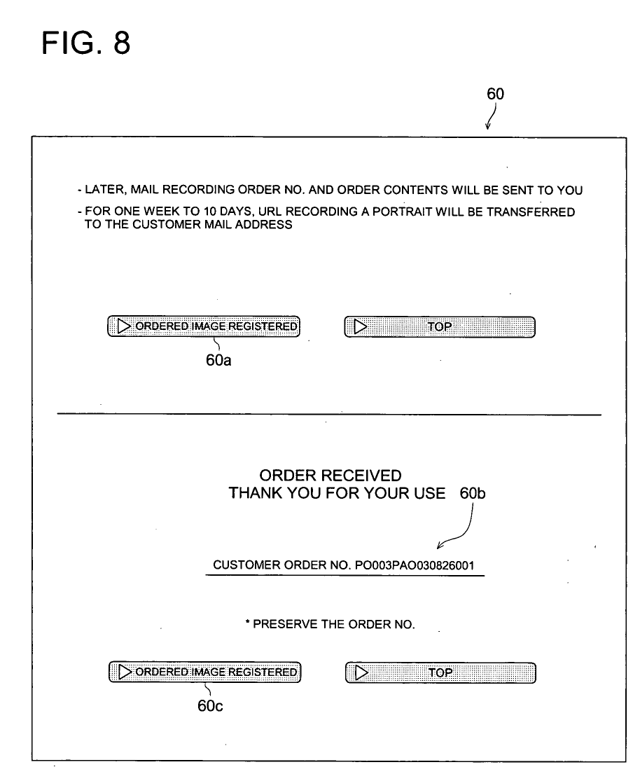

FIG. 7 shows the ordering content confirmation screen. At the user terminal 3 in this embodiment, on an ordering content confirmation screen 50 shown in FIG. 7, the ordering contents are confirmed by a user information confirmation display 50a and a portrait setting information confirmation display 50b. The ordering content confirmation screen 50 is equipped with an ordering button 50c, a portrait information changing button 50d, a user information input changing button 50e, and a gear cancel button 50f and when the ordering button 50c is clicked, the order confirmation screen shown in FIG. 8 is displayed.

On the order confirmation screen 60, when an ordered image registering button 60a is clicked, mail recording order No. 60b and ordering contents is received and when an ordered image registering button 60c is clicked, the ordering is finished.

Hereafter, for a predetermined period, for example, for one week to 10 days, the creating of the ordered image is completed and to the user's mail address, the URL recording a portrait is transmitted.

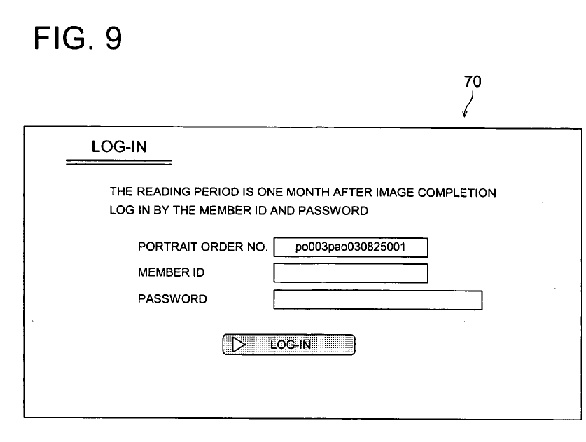

FIG. 9 shows the log-in screen to the URL and the created digital image can be read by the user by the URL of the ordering manager. On a log-in screen 70 to the URL in this embodiment, the user logs in by the member ID and password and can read the created digital image by inputting the portrait order number. The user reads the digital image like this and when there is a respect which cannot be satisfied by the user, he can transmit a correction instruction and correct the digital image.

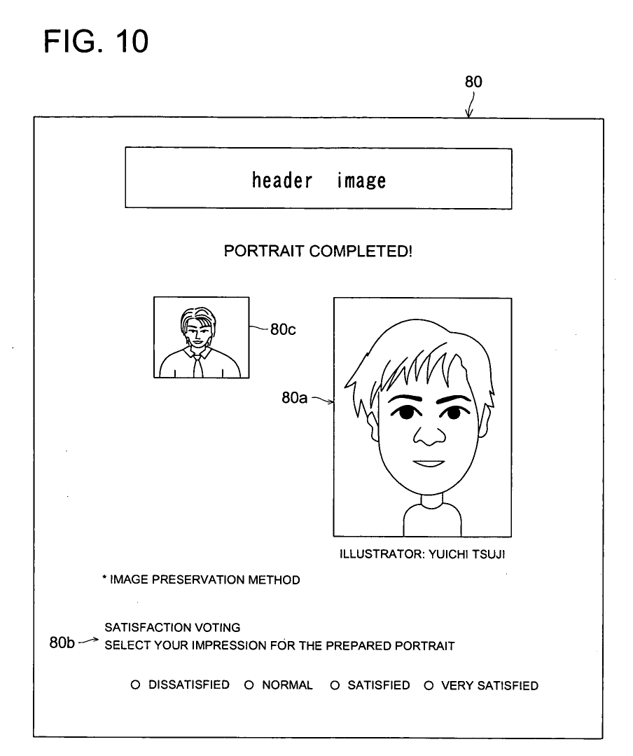

FIG. 10 shows the satisfaction voting screen. A satisfaction voting screen 80 in this embodiment has a created image display 80a, a satisfaction voting unit 80b, and a created original image display 80c and the satisfaction is voted by evaluation of dissatisfied, normal, satisfied, and very satisfied. For example, dissatisfied is evaluated by [−1], normal by [0], satisfied by [+1], and very satisfied by [+2]. As mentioned above, the popularity is decided by voting of satisfaction by the user from the user terminal 3 on the basis of the created image and an image preparer reflected by the satisfaction of the user can be selected.

Further, the popularity may be decided by the selection count of each image preparer from the user terminal 3 and an image preparer reflected by the selection count of the user can be selected.

The completed portrait can be ordered by entering in original goods (calling card, memo, etc.) of the online lab, a post card, or a calendar. Further, the completed portrait can be preserved in the online lab.

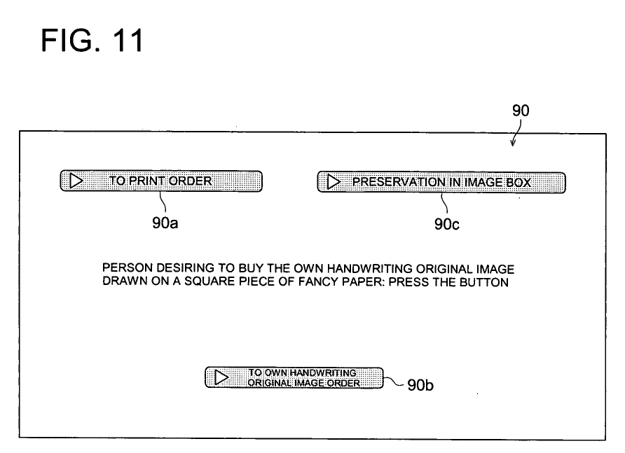

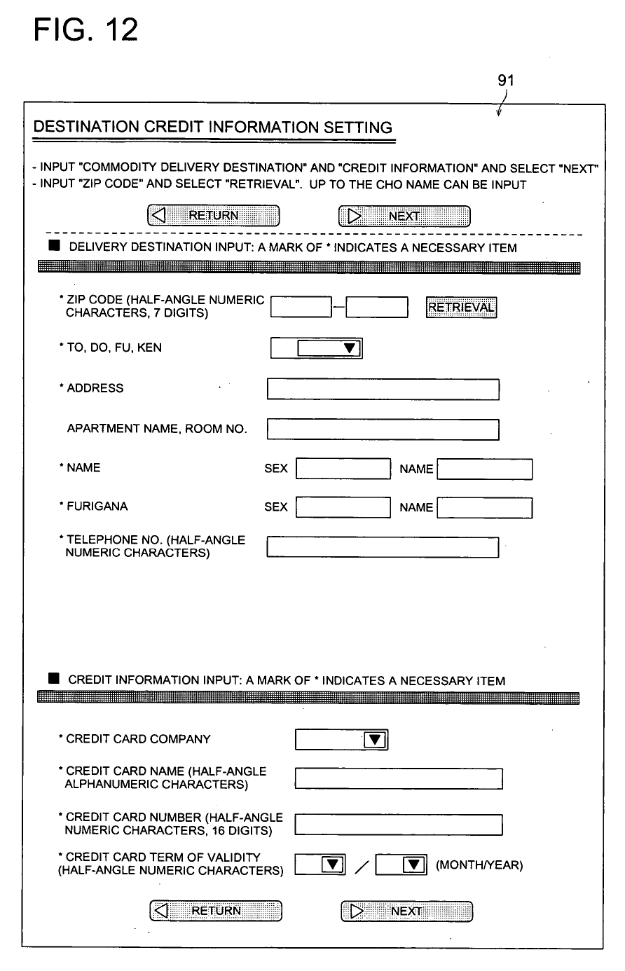

FIG. 11 shows the ordering screen of a created image. An ordering screen 90 in this embodiment has a print ordering button 90a, an own handwriting original image ordering button 90b, and an image box preservation button 90c. When the own handwriting original image ordering button 90b is clicked, an own handwriting original image ordering screen 91 shown in FIG. 12 is displayed. On the own handwriting original image ordering screen 91, destination credit information is set.

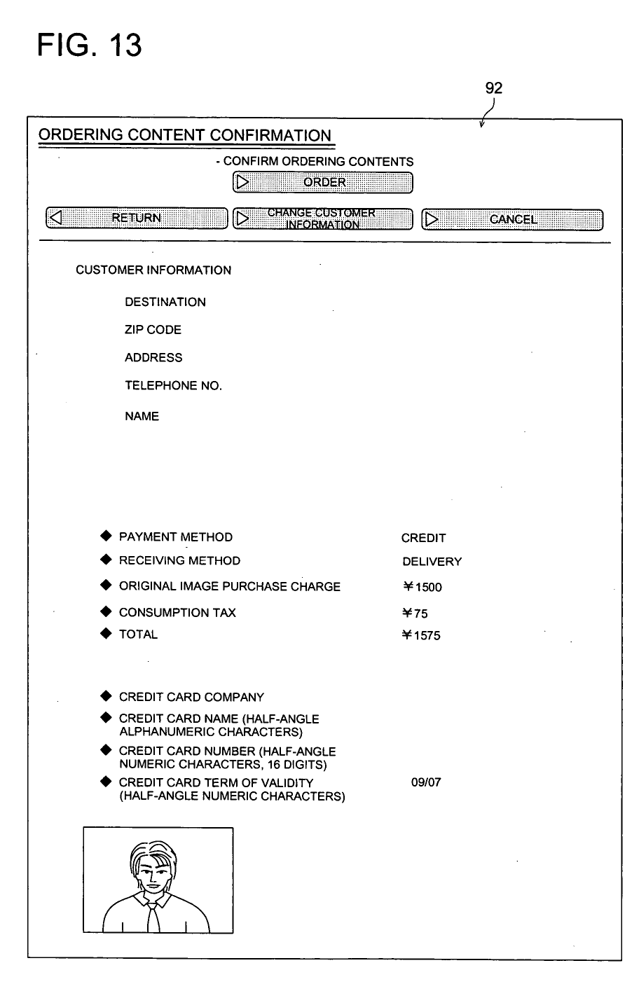

Further, when the print ordering button 90a on the ordering screen 90 is clicked, a print ordering screen 92 shown in FIG. 13 is displayed. On the print ordering screen 92, destination credit information is set.

According to the present invention, a predetermined image preparer is selected from the selection information of a plurality of image preparer from the user terminal 3, and image creation is ordered to the selected image preparer, thus the user can receive image creating services of a desired portrait or images of buildings and famous places. Moreover, the image creating service of at least a portrait is received, so that the present invention can be used for various applications such as the Web screen or portable standby. Furthermore, the image creating includes a digital image and an own handwriting original image, and the digital image is used for, for example, the Web screen or portable standby, and the own handwriting original image is used as a present or for appreciation, so that how to enjoy can be extended more.

This image creating service system can be applied to a service system capable of receiving image creating services of a portrait or an image such as a building or a famous place by selecting a desired image preparer by a user.

1. An image creating service system comprising;
a network,
a user terminal to order image creation, to connect the network,
an ordering server to store selection information of a plurality of image preparer, to connect the network,
a displaying device to display the selection information,
a selecting device to select an image preparer by the user terminal, according to the displayed selection information,
an ordering device to order image creation to the selected image preparer, and,
a sending device to send information of necessity for creating image to the selected image preparer.

2. The image creating service system of claim 1, wherein the information of necessity for creating image includes photographic image of the user.

3. The image creating service system of claim 1, wherein the kind of ordered image creation includes a portrait of the user.

4. The image creating service system of claim 1, wherein the selection information of a plurality of image preparer includes at least one of the name of the image preparer, portrait, profile, style, sample image, popularity, existence of an own handwriting original image order, and created image kind.

5. The image creating service system of claim 4, wherein the popularity of image preparer determines based on the degree of satisfaction voted from the user terminal, according to the created image.

6. The image creating service system of claim 4, wherein the popularity of image preparer determines based on the selected number of times from the user terminal.

7. The image creating service system of claim 1, wherein the sending device to send the original image of image creation to the ordering server via the network as the information of necessity for creating image.

8. The image creating service system of claim 1, wherein the image preparer to create image includes at least one of a digital image and an autograph image.

9. The image creating service system of claim 8, further comprising;
a digital image sending device to send the URL for display the created digital image to a user, wherein the user can browse the created digital image according to access the URL.

10. The image creating service system of claim 8, wherein the ordering device to order own handwriting original image from the user terminal, wherein the own handwriting original image is created by the image preparer.

11. The image creation service system of claim 1, further comprising;
an evaluating device to evaluate the image preparer by user, according to the created image.

12. An image creation ordering method comprising steps of;
displaying the selection information of a plurality of image preparer to a user terminal, wherein the user terminal to connect to a network,
selecting an image preparer according to the displayed selection information,
ordering image creation to the image preparer,
sending information of necessity for creating image to the selected image preparer, and
evaluating the image preparer by user, according to the created image.
